(19) United States
(12) Patent Application Publication
(10) Pub. No.: US 2002/0049506 A1
(43) Pub. Date: Apr. 25, 2002

(54) Sensor system for detecting location/position and/or speed and/or acceleration, drive control system based on this, and method of networking a control unit with one or more sensor systems

(76) Inventors: Gunther Birk, Erlangen (DE); Ulrich Hahn, Fuerth (DE); Michael Spingler, Herzogenaurach (DE); Jens Weidauer, Hoechstadt (DE)

Correspondence Address: BAKER & BOTTS, 30 ROCKEFELLER PLAZA, NEW YORK, NY, 10112

(21) Appl. No.: 09/918,577

(22) Filed: Jul. 31, 2001

(30) Foreign Application Priority Data
Sep. 27, 2000 (DE) 100 479 24.3

(51) Int. Cl. G05B 11/32

(52) U.S. Cl. 700/69

(57) ABSTRACT

According to the present invention, an analog evaluation circuit, the digitization and the conversion into physical variables are moved from the higher-order control system into the sensor system, and the control system is connected to this new sensor system through a synchronous high-speed transmission system. This serial real-time sensor interface provides the network capability of the transmission system and also permits simpler cabling.

### FIELD OF THE INVENTION

The invention relates to a sensor system for the digital control of power and rotational speed of electric drivers for detecting location, position, speed, or acceleration, and more particularly to a drive control system based on such a sensor system.

### BACKGROUND OF THE INVENTION

Information about the location, position, speed in a power converter motor in a respective control cycle is needed for the digital control of power and rotational speed of electric drives. Since the control cycle rates of the power converter motor are almost always above 1 kHz, and a minimum dead time between the detection of values relating to the location, position, speed, and the like, and the availability of the values in a control system is required, the information relating to the values is provided as raw analog signals in conventional sensor systems. The raw analog signals are transported through shielded cables to control electronics. The control electronics condition the raw analog signals in analog form, and convert the raw analog signals into digital signals, which are in turn converted into physical variables before they can be used by the control system. Therefore, the control electronics has to include an analog evaluation circuit corresponding to the particular sensor system and have precise knowledge of the functioning and type of the sensor detecting the values in order to be able to use the raw analog signals.

Furthermore, analog signal transmission is complicated and very susceptible to interference. In some cases, interference cannot be distinguished from the useful signal. Digital transmission techniques are not nearly as prone to this type of interference. However, digital transmission techniques, already being employed for other applications in industrial automation, for example EnDat, SSI, Hyperface or Profibus, for sensor signals, do not meet the high requirements relating to cycle rate and dead time of the power and speed control systems.

### SUMMARY OF THE INVENTION

It is therefore an object of the present invention to provide a sensor system for secure, flexible and real-time-capable current value transmission. In accordance with a preferred embodiment of the present invention, a sensor system is provided for detecting at least one of the following: location, position and speed. The system includes a signal generator, preferably based on magnetics or optics, for generating an analog sensor signal, an evaluation circuit for the analog sensor signal, an analog/digital converter for converting the evaluated analog sensor signal into a digital output variable, a computing means for conversion into a digital physical output variable, in particular into at least one of a speed value, an acceleration value, and a position value. The system further includes an output interface for transmitting the digital physical output variable to a higher-order processing unit at synchronous deterministic times, in particular at a control cycle rate of the higher-order processing unit. Preferably, the synchronous output interface can be implemented as a serial interface.

Alternatively, the synchronous interface can be implemented as a bus system, and simple drive control systems may be built, which can have a multiplicity of coupled means, for example numerically controlled handling machines such as machine tools and robots. If the synchronous interface is implemented as a bus system, it is preferred if the signal generators are implemented as resolvers or high-resolution optical encoders, with and without multiturner stage. The synchronous interface can also be implemented as a communication system with a master-slave structure, in which the control unit is a master and the sensor system is a slave. Using a master-slave structure allows a plurality of sensor systems to be operated with one control unit.

In a preferred embodiment, the sensor system transmits at least one of a temperature, pressure, and flow values from a drive through the synchronous interface to the control unit as digital physical output variables.

In accordance with a further preferred embodiment of the present invention, a method is provided for networking a control unit with at least one sensor system including decoupling the respective sensor physics and the respective evaluation circuit from the controlled electronics; moving the respective sensor physics and the respective evaluation circuit into the respective sensor system; and communicating between the control unit and each sensor system by means of a general digital transmission protocol.

Important technical advantages resulting from the aforesaid embodiments of the present invention include significantly higher data transmission integrity, incorporation of security mechanisms such as cyclic redundancy check sums, the ability to make independent innovations in sensor systems and control systems, additional data, such as speed, acceleration, temperature, pressure and the like can be provided to the control system, automatic adaptation in the control software to the data made available, the automatic detection of sensor faults, and simpler cabling as a result of series connection.

Further advantages and details of the present invention are disclosed in the context of the following exemplary embodiment and drawings, in which elements with the same functionality are identified by the same reference symbols.

### BRIEF DESCRIPTION OF THE DRAWINGS

FIG. 1 illustrates a communication network with a drive control system and three sensor systems according to the present invention.

FIG. 2 illustrates a block diagram of a sensor system based on a resolver according to the present invention.

### DETAILED DESCRIPTION OF THE INVENTION

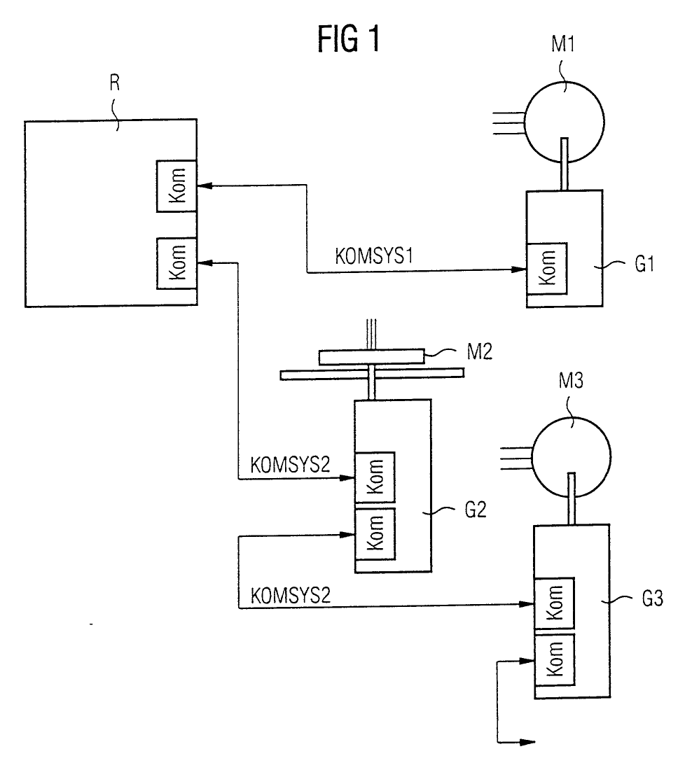

FIG. 1 illustrates a communication network with a drive control system and three sensor systems G1, G2, G3. The drive control system for three motors M1, M2, M3 includes a communication network having two different communication systems KOMSYS1 and KOMSYS2, through which the sensor systems G1, G2, G3, each associated with the motors M1, M2, M3, respectively, communicate with a higher-order control unit R. While the motors M1 and M3 are rotational drives, the motor M2 is a linear motor. The motors M1, M2, M3 as illustrated can be three coupled drives in an industrial processing machine, for example a machine tool or a robot.

The entire analog sensor signal evaluation is moved into the sensor system G1, G2, G3, and therefore physical variables, such as position, rotational speed, acceleration, temperature, pressure, flow, and the like can be generated in the sensor systems G1, G2, G3. A high-performance synchronous transmission system KOMSYS1 and KOMSYS2 transmits the physical variables from the sensor systems G1, G2, G3 to the higher order control unit R. Generating physical variables in the sensors G1, G2, G3 and transmitting them to the higher order control unit R, allows the higher order control unit R to be decoupled from the individual sensors G1, G2, G3. In this case, the availability of real-time sensor data is ensured at control cycle rates far above 1 kHz, by data cycle times of considerably less than 1 ms being possible. The dead time for the transmission of the synchronous data from a sensor is considerably less than 20 μs.

Each of the control unit R and the sensor systems G1, G2, G3, has at least one respective communication modules Kom. A communication module Kom 104 of the higher-order control unit R is connected to a communication module Kom 106 of the sensor system G2 by the communication system KOMSYS2, and a communication module Kom 102 of the higher-order control unit R is connected to a communication module Kom 114 of the sensor system G1 by the communication system KOMSYS1. A communication module Kom 108 of the sensor system G2 is connected to a communication module Kom 110 of the sensor system G3 by the communication system KOMSYS2.

In an alternate embodiment, a bus structure, through which the communication may be carried out, may also be involved.

The control unit R and the sensor systems G1, G2, G3 can have more than one such communication module, which allows networking between a plurality of components to be achieved. The communication system KOMSYS2 can be constantly led onward to additional network participants. The communication modules Kom 102, 104, 106, 108, 110, 112, 114 process the digital transmission protocol, and permit the control unit R to be supplied with the necessary sensor values at the control cycle rate.

An example of the synchronous transmission system is a communication network based on Ethernet connections, which is optimized through a suitable digital transmission protocol to form a time-deterministic transmission system. The standardized transmission layer 2, i.e. telegram frame and access method, of the fast Ethernet is redefined by a new data protocol and a new access control system to comply with the requirements of real-time transmissions and high data integrity. Therefore, Ethernet connections may be used as a basis for real-time communication between, drive components, the control unit R and the sensors G1, G2, G3.

In order to employ a master-slave relationship between network participants, it is preferred if the slave units (here the sensor systems G1, G2, G3) are synchronized with the master unit (here the control unit R). Each slave unit is clocked with a respective timer at a predefined overall cycle time, which is set cyclically by the receipt of a respective item or telegram of slave-specific synchronization information determined by the master unit.

A master-slave communication architecture is therefore employed. In order to be able to implement cyclic data interchange with identical sampling times, a common time base for the master and all the slaves is produced. The synchronization of the slaves with the master is carried out by specifically distinguished, time-defined telegrams from the master to the slaves and by individually configured timers in the slaves. In this case, useful data telegrams and specific synchronization telegrams, which contain the respective synchronization information, can be transmitted. Alternately, the synchronization information can also be integrated into a distinctive useful data telegram.

The stability of the communication system can be increased if each timer in a slave unit automatically starts a new cycle after the expiration of the predefined overall cycle time, even if the respective synchronization information is missing.

For the transmitting and receiving operation in the cyclic data transmission, use is made, for example, of a time-slot access method, which is initiated by the master in the network and permits dead-time-optimal data transmission. As a result, the telegrams can be monitored precisely with respect to a transmission which is disrupted, premature or delayed. To this end, only the master unit has transmission authorization on the communication system for the purpose of initialization and through a corresponding slave-specific telegram informs each slave unit (which has only response authorization, in addition to the overall cycle time) the time slots within the overall cycle time in which the respective slave unit will receive switch telegrams from the master unit and in which time slots it is to send its telegrams. In this case, it has proven to be advantageous if each slave unit is informed as to the respective synchronization time in the initialization phase. If, in each slave unit, respective instantaneous values, location values, speed values, and the like, are stored at a common time, in particular at the start of a cycle, simultaneous and equidistant sampling for the control unit R may be achieved.

In addition, in each telegram transmitted by the master unit to a slave unit, monitoring information may be provided, with which safety-oriented functions provided directly in the slave unit may be activated.

The useful data can be transported in a telegram frame which, in addition to the slave addressing and telegram length information, provides the safeguarding of the data integrity by means, for example, of a cyclic redundancy check sum and further safety-relevant data areas. The data in the telegram frame can be evaluated not only by an application processor but also by a communication module Kom. To this end, each slave unit sends a signal to the master unit with each telegram. If the signal is missing, the master unit stops the corresponding slave unit in a controlled manner.

Although the transmission technique in accordance with the Ethernet standard which is employed in principle permits only point-to-point connections, the formation of networks can also be made possible by the use of network nodes (HUBs), as in the case of fast Ethernet networks by a plurality or each communication participant having a circuit part to form a network node which is used to forward the telegrams in the direction of another master unit or further slave units. Communication between communication participants is carried out through network nodes, likewise in accordance with the procedure described above.

In accordance with the foregoing disclosure, real-time communication can be achieved on the basis of a communication system based on Ethernet connections. In this case, hierarchical networks with point-to-point Ethernet connections connected through network nodes can also be set up in relatively large network topologies in order to carry out real-time communication. The same is also suitable for the networking or coupling of a distributed drive system, with a control unit R serving as a master unit in a communication system KOMSYS1 or KOMSYS2 which has at least one associated sensor system G1, G2, G3 as a slave unit.

Communication between the drive components (such as control unit R, sensor systems G1, G2, G3, and further components such as power parts and movement control systems) can be optimized by an existing high-performance transmission system from office communication by means of a completely new protocol, master-slave synchronization and time-slot access methods. This provides real-time capability, even where very time-critical applications with a control cycle rate above 1 kHz may be implemented. In addition, the minimum desk-time implementation permits highly dynamic control loops to be closed through the serial communication system.

In order to implement the sensor systems G1, G2, G3 according to the invention and their networking with a control unit R, other communication networks than that described above by way of example can also be used, presupposing that the bandwidth of the transmission ensures the communication at the control cycle rate and with optimum dead-time.

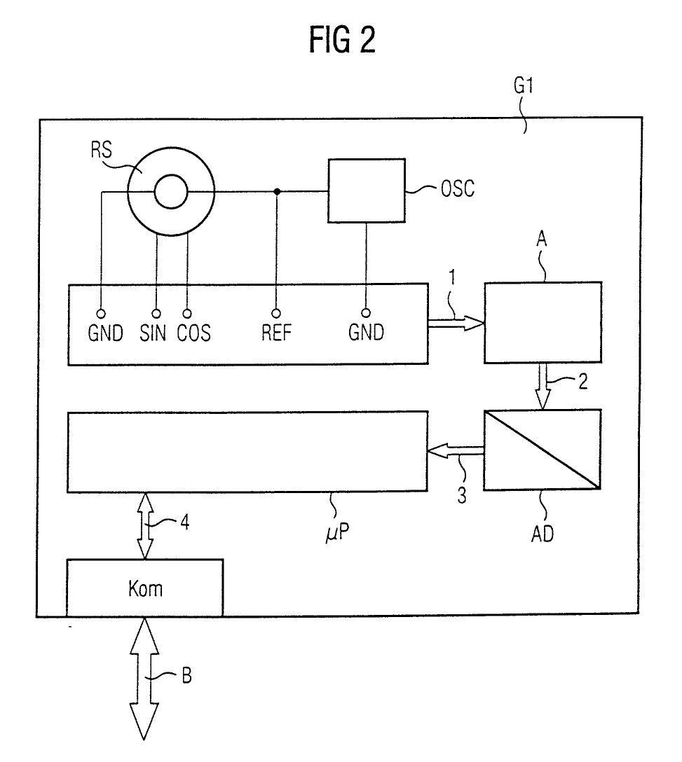

FIG. 2 shows a block diagram of the sensor system G1. A signal-generating element based on a transmitter/resolver RS is used; however, signal generators based on a different technical principle, such as high-resolution optical systems or magnetic systems, may also be used. The resolver RS is connected to an oscillator OSC for generating reference signals REF and, after demodulation, supplies rotor location data in the form of sine SIN and cosine COS signals. The sine SIN and cosine COS signals are the raw analog signals. In addition, the resolver RS and the reference oscillator OSC have ground connections GND, through which both elements are brought to the same reference potential.

The raw analog signals 1, generated in this way, are supplied to an evaluation circuit A, for example in the form of a suitably programmed memory module, for sine evaluation. The evaluated sensor signals 2 are converted into digital data 3 in an analog/digital converter AD and supplied to a computing unit μP. One representation of the signals generated in this way on the basis of a resolver RS is provided in the text book “Moderne Stromrichterantriebe” [Modern Converter Drives] by P. F. Brosch, First Edition, Wurzburg: Vogel-Verlag, 1989, on page 187.

The control/computing unit μP is used to convert the digital sensor signals 3 into a digital physical output variable 4 which may comprise a speed value, an acceleration value, a location value, and a position value. The digital value, determined in this way, represents a physical variable which is needed by the control unit R to drive the respective motor M1 associated with the sensor system G1. The digital value is supplied to a synchronous output interface Kom for transmission to the higher-order processing unit R.

The communication interface or the communication module Kom processes the respectively implemented digital transmission protocol which, for example, can appear like the transmission described above based on Ethernet connections. It is therefore possible for the control unit R to be supplied with the necessary physical values as digital data through the real-time sensor interface, for example a communication system B. For this purpose, the control unit R does not need to have any kind of knowledge about the sensor physics or about the evaluation by its signal-generating elements. As a result, different sensor systems can be operated on one and the same control unit R, without the latter having to be optimized specifically for specific sensor physics.

Although the present invention has been described with several embodiments, a myriad of changes, variations, alterations, transformations, and modifications may be suggested to one skilled in the art, and it is intended that the present invention encompass such changes, variations, alterations, transformations, and modifications as are covered by the scope of the appended claims.

What is claimed is:

1. A sensor system in a power converter motor for detecting at least one of a location, a position, a speed, and an acceleration thereof, comprising a signal generator for generating an analog sensor signal, an evaluation circuit for creating an evaluated analog sensor signal from the analog sensor signal, an analog/digital converter for converting the evaluated analog sensor signal into a digital output variable, a computing means for conversion of the digital output variable into a digital physical output variable value consisting of at least one of a speed value, acceleration value, and a location/position value, and an output interface for transmitting the digital physical output variable value to a higher-order processing unit at synchronous deterministic times.

2. The sensor system according to claim 1, wherein the synchronous output interface is a serial interface.

3. The sensor system according to claim 1, wherein the synchronous interface is a bus system.

4. The sensor system according to claim 1, wherein the signal generator is a resolver.

5. The sensor system according to claim 1, wherein the signal generator is an optical encoder.

6. A drive control system comprising a sensor system, including a signal generator for generating an analog sensor signal, an evaluation circuit for creating an evaluated analog sensor signal from the analog sensor signal, an analog/digital converter for converting the evaluated analog sensor signal into a digital output variable, a computing means for conversion of the digital output variable into a digital physical output variable value consisting of at least one of a speed value, acceleration value, a location/position value, and an output interface for transmitting the digital physical output variable value to a higher-order processing unit at synchronous deterministic times, and a control unit which communicates with the sensor system through the output interface of the sensor system at a controller cycle rate of the higher-order processing unit.

7. The drive control system according to claim 6, wherein the output interface is a communication system with a master-slave structure in which the control unit is a master and the sensor system is a slave.

8. The drive control system according to claim 6, wherein the sensor system is configured to transmit at least one of a temperature, a pressure, and a flow value from a drive through the output interface to the control unit as digital physical output variables.

9. A method of networking a control unit with one or more sensor systems, comprising decoupling the respective sensor physics and the respective evaluation circuit from the control electronics and moving them into the respective sensor system, and effecting communication between the control unit and each sensor system by means of a digital transmission protocol.
